(19) United States
(12) Patent Application Publication
(10) Pub. No.: US 2009/0207372 A1
(43) Pub. Date: Aug. 20, 2009

(54) Combined lens rim injection molded with soft raw material

(75) Inventor: Ching-Fu Chuang, Tainan City (TW)

Correspondence Address: Ching-Fu Chuang, P.O. Box 6-9, Tainan, 717, TW

(73) Assignee: JIHN MEI OPTICAL CO., LTD.

(21) Appl. No.: 12/070,460

(22) Filed: Feb. 20, 2008

(51) Int. Cl. G02C 5/00

(52) U.S. Cl. 351/154

(57) ABSTRACT

A combined lens rim injection molded with soft raw material includes an upper rim and a lower rim combined together. The upper rim and the lower rim are designed to be so simple that the lens rim can easily be released from the mold through the opening. By so designing, in case of opening the mold, the upper rim and the lower rim can be automatically released from the mold by means of ejector pins or mechanical arms, able to save man power for removing the lens rim out of the mold, simplify a solid lens-rim mold and reduce cost of opening mold as well as time required for injection molding.

### BACKGROUND OF THE INVENTION

1. Field of the Invention

This invention relates to a combined lens rim injection molded with soft raw material, particularly to one convenient to be automatically released from a mold and needless to employ man power for removing an injection molded product from the mold.

2. Description of the Prior Art

Generally, goggles with replaceable lenses are employed for avoiding external things directly getting into a worker's eyes and causing an accident. The lens of the goggles can be replaced according to different working environments and needs different lens, or when the lenses of the goggles are damaged, scraped or soiled.

A conventional way of producing a lens rim is to have rubber material directly injected in between a male mold and the cavity of a female mold and, after the lens rim is cooled off and hardened, the two molds are separated. Since the surface of the male mold is bulging, the injection molded product will adhere to the surface of the male mold after the two molds are separated. For facilitating the shaped product to be removed from the male mold, the male mold is provided with ejector pins for injecting parts of the shaped product out of the surface of the male mold and then the shaped product is completely removed out manually. However, when a product is shaped, the inside wall of the product is curvedly, not flatly, stuck around the surface of the male mold; therefore, when the shaped product is to be manually removed from the surface of the male mold, it has to be stripped step by step along the male mold, thus taking too much time and labor in releasing the shaped product from the mold.

### SUMMARY OF THE INVENTION

The objective of this invention is to offer a combined lens rim, which is able to be easily released from a mold after injection molded.

The feature of the invention is an upper rim and a lower rim consisting the combined lens rim, and the upper and the lower rim are provided with an insetting member for a lens to be inset and a combining member for combining the upper and the lower rim together.

### BRIEF DESCRIPTION OF DRAWINGS

This invention will be better understood by referring to the accompanying drawings, wherein:

FIG. 1 is a perspective view of a first preferred embodiment of an injection molded lens rim in the present invention;

FIG. 2 is an exploded perspective view of the first preferred embodiment of the injection molded lens rim in the present invention;

FIG. 3 is a perspective view of the first preferred embodiment of the injection molded lens rim to be combined with a lens in the present invention;

FIG. 4 is a perspective view of the first preferred embodiment of the injection molded lens rim combined with the lens in the present invention;

FIG. 5 is a cross-sectional view of the first preferred embodiment of the lens rim having a lens inset thereon in the present invention;

FIG. 6 is an exploded perspective view of a second preferred embodiment of an injection molded lens rim in the present invention;

FIG. 7 is a perspective view of the second preferred embodiment of the lens rim being combined with a lens in the present invention;

FIG. 8 is a perspective view of an injection molded snow lens rim in the present invention; and

FIG. 9 is an exploded perspective view of the injection molded snow lens rim in the present invention.

### DETAILED DESCRIPTION OF THE PREFERRED EMBODIMENT

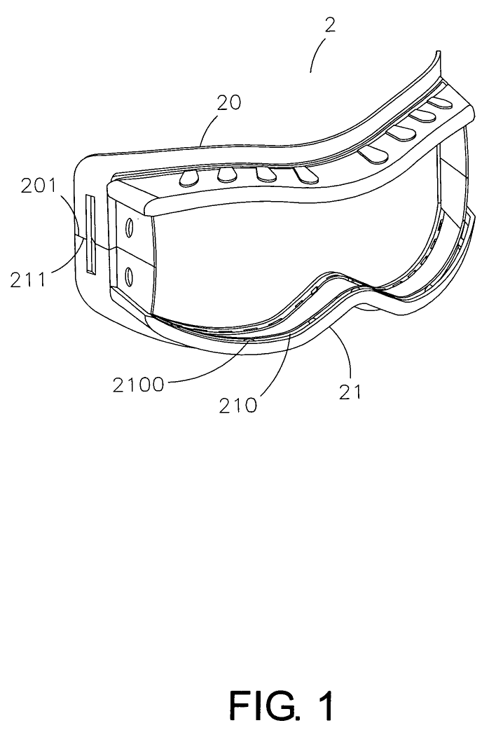

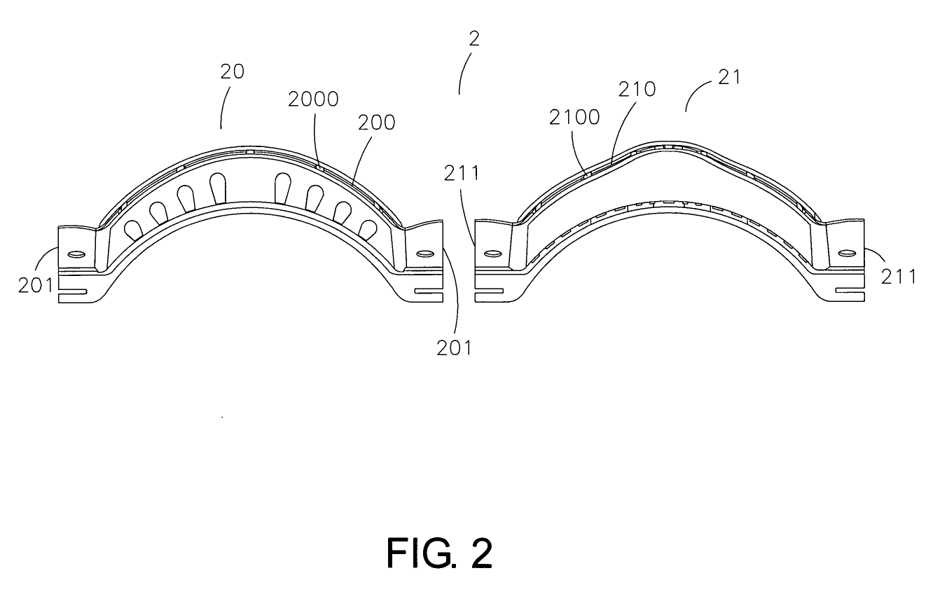

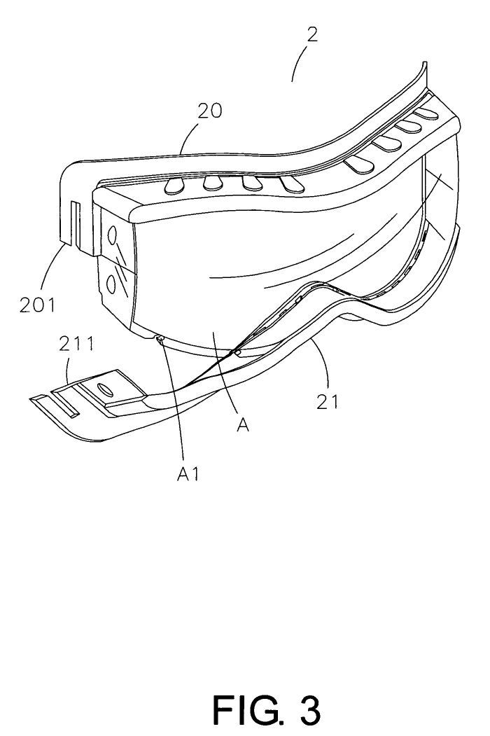

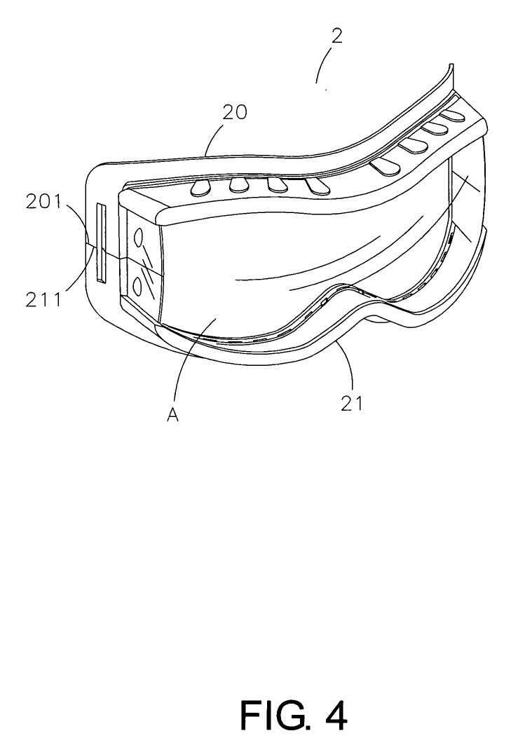

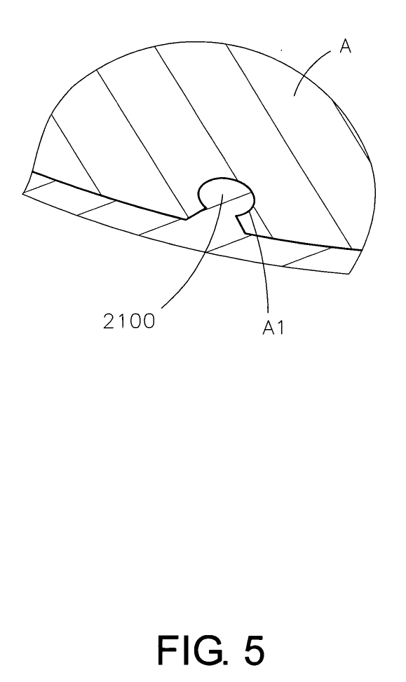

A first preferred embodiment of a combined lens rim injection molded with soft raw material in the present invention, as shown in FIGS. 1 to 5, includes an upper rim 20 and a lower rim 21. The upper rim 20 and the lower rim 21 are solid bodies made of soft material and respectively provided with an insetting member 200 and 210 to be inset with a lens (A), and a combining member 201 and 211 for combining the upper rim 20 and the lower rim 21 together. The insetting members 200 and 210 able to be closely combined with the rim edge of the lens (A) are respectively disposed thereon with a plurality of engage projections 2000, 2100 to be respectively engaged with the engage recesses A1 of the lens (A). Thus, the upper rim 20 and the lower rim 21 are formed into a two-dimension simple plane to enable the upper and the lower rim 20, 21 to be automatically released from a mold comparatively simply and easily.

In combining, the lens (A) is inset in the insetting member 210 of the lower rim 21 and then the upper rim 20 is inset with the lens (A) from above, letting the upper portion of the lens (A) inserted in the insetting member 200 of the upper rim 20. Thus, the lens (A) is closely combined together with the upper and the lower rim 20, 21. Lastly, the combining members 201 and 211 of the upper and the lower rim 20 and 21 are firmly combined together to finish assembling a pair of eyeglasses with a soft lens rim.

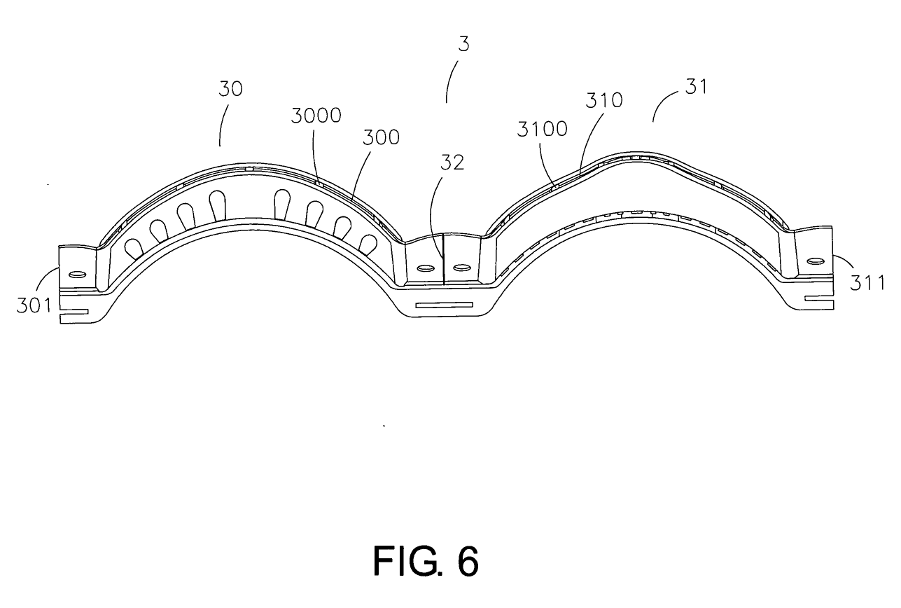

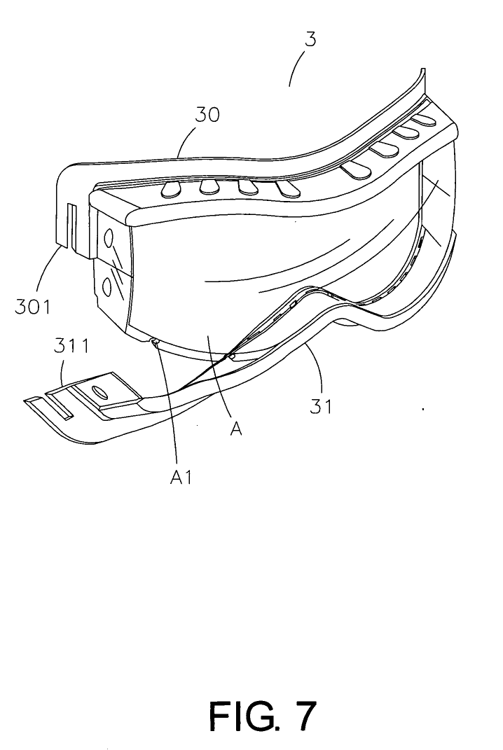

A second preferred embodiment of a lens rim 3 in the present invention, as shown in FIGS. 6 and 7, includes an upper rim 30 and a lower rim 31 combined together. The upper rim 30 and the lower rim 3 1 are solid bodies made of soft material and respectively having one side provided with a connecting member 32 connecting the upper rim 30 and the lower rim 31 together. Further, the upper rim 30 and the lower rim 31 are respectively disposed with an insetting member 300, 310 able to be closely combined with the edge of a lens (A), and respectively have the other side formed with a combining member 301, 311 for combining the upper rim 30 and the lower rim 31 together. Thus, the upper rim 30 and the lower rim 31 are formed into a two-dimension simple plane to enable the upper and the lower rim 30, 31 to be automatically released from the mold simply and easily.

In combining, the insetting member 310 of the lower rim 31 is first inset with the lens (A) and then the insetting member 300 of the upper rim 30 is inset with the lens (A) along the outer circumferential edge of the lens (A). After the lens (A) is completely positioned in the upper and the lower rim 30 and 31, the combining members 301 and 311 at the other end of the upper and the lower rim 30 and 31 are engaged with the lens (A) and combined together.

As can be understood from the above description, this invention has the following advantages.

1. The lens rim 2 of this invention can easily be combined with the lens (A) by having the insetting members 200, 210 of the upper and the lower rim 20, 21 respectively engaged with the circumferential edge of the lens (A) and then having the combining members 201, 211 combined together.

2. The lens rim 2 is composed of the upper rim 20 and the lower rim 21; therefore, the cost of shaping molds can be lowered, and the upper rim 20 and the lower rim 21 can be released from the mold comparatively easily. In addition, in this invention, a three-dimension curved lens-rim mold is simplified into a two-dimension plane lens-rim mold, able to speed up shaping work and lower cost of opening a mold.

3. In this invention, a two-dimension lens-rim mold takes the place of a three-dimension lens-rim mold for shaping the lens rim 2, and then the lens (A) is inset and positioned on the lens rim 2, able to keep the integrity of eyeglasses.

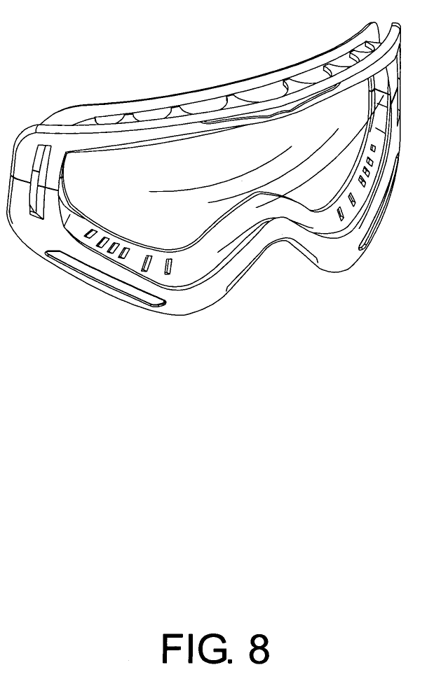

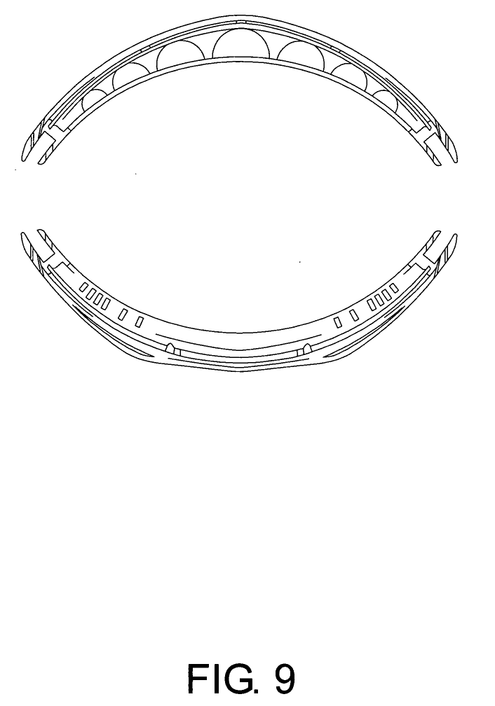

4. The method of shaping the lens rim 2 in this invention can be applied to shaping a snow lens rim, as shown in FIGS. 8 and 9, thus effectively lowering costs in developing complicated molds, reducing injection molding time and facilitating removing a shaped product from a mold by mechanical arms for saving man power and cost.

While the preferred embodiments of the invention have been described above, it will be recognized and understood that various modifications may be made therein and the appended claims are intended to cover all such modifications that may fall within the spirit and scope of the invention.

I claim:

1. A combined lens rim injection molded with soft raw material, said lens rim comprising an upper rim and a lower rim, said upper rim and said lower rim being solid rim bodies respectively provided therein with an insetting member and having two opposite ends respectively disposed with a combining member, in case of opening a mold said upper rim and said lower rim able to be automatically released from said mold by means of ejector pins or mechanical arms so as to save man power in removing said upper rim and said lower rim out of said mold and also reduce cost of opening mold as well as time required for injection molding.

2. The combined lens rim injection molded with soft raw material as claimed in claim 1, wherein said upper rim and said lower rim are respectively disposed with a plurality of air holes and curved surfaces to let a wearer feel comparatively comfortable.

3. The combined lens rim injection molded with raw material, said lens rim comprising an upper rim and a lower rim combined together, said upper rim and said lower rim shaped into a solid rim body, said upper rim and said lower rim respectively having one side provided with a connecting member and another side disposed with a combining member, said upper rim and said lower rim respectively formed with an insetting member for a lens to be inset and positioned therein, in case of opening a mold said upper rim and said lower rim able to be automatically released from said mold by means of ejector pins or mechanical arms so as to economize man power for removing said lens rim from a mold and simplify a solid lens-rim mold and also lowering cost of opening molds as well as saving time required for injection molding.

4. The combined lens rim injection molded with soft raw material as claimed in claim 3, wherein said upper rim and said lower rim are respectively disposed with a plurality of air holes and curved surfaces to let a wearer feel comparatively comfortable.
